(19) United States
(12) Patent Application Publication
(10) Pub. No.: US 2021/0379893 A1
(43) Pub. Date: Dec. 9, 2021

(54) INKJET PRINTER AND EJECTION DEVICE MAINTENANCE

(71) Applicant: Hewlett-Packard Development Company, L.P., Spring, TX (US)

(72) Inventors: Jui Hong Lim, Singapore (SG); Chemg Linn Teo, Singapore (SG); Chee Beng Teo, Singapore (SG); Bryan Delima Yrogirog, Singapore (SG); Deyang Wang, Singapore (SG)

(73) Assignee: Hewlett-Packard Development Company, L.P., Spring, TX (US)

(21) Appl. No.: 17/286,550

(22) PCT Filed: Dec. 6, 2018
(86) PCT No.: PCT/US2018/064175

§ 371 Date: Apr. 19, 2021

(51) Int. Cl. B41J 2/165

(52) U.S. Cl. CPC B41J 2/16508

(57) ABSTRACT

An inkjet printer comprising an ejection device, movably provided along a print zone and a spit zone, a printer controller to control ejection device maintenance, a spittoon located in the spit zone to receive maintenance ink ejected by the ejection device in the spit zone when ejection device maintenance is performed, is provided. The printer controller is to set a random spit position within the spit zone at which the ejection device is to eject the maintenance ink into the spittoon and to cause the ejection device to move to the set random spit position and to eject the maintenance ink into the spittoon at the random spit position.

### BACKGROUND

Ejection devices for inkjet printers have to go through maintenance measures from time to time, in order to prevent ink ejecting nozzles from clogging by plugs formed by dried ink or the like.

### BRIEF DESCRIPTION OF THE DRAWINGS

Features and examples will be described, by way of example only, in the following detailed description with reference to the accompanying drawings in which like reference numerals correspond to similar, though perhaps not identical, components. For the sake of brevity, reference numerals or features having a previously described function may or may not be described in connection with other drawings in which they appear.

FIG. 1 schematically illustrates a printer assembly including a spit zone arranged on the right-hand side of a print zone and a capping station arranged on the left-hand side of a print zone.

FIG. 2a schematically illustrates an ejection device performing a maintenance spit at a first random spit position within a print zone.

FIG. 2b schematically illustrates an ejection device performing a maintenance spit at a second random spit position within a print zone.

FIG. 3a schematically illustrates a spit zone in segmented in three spitting segments and a black color ejection device performing a maintenance spit at a random position in a first third of the spit zone.

FIG. 3b schematically illustrates the segmented spit zone of FIG. 3a, with a black color ejection device performing a maintenance spit at a random position in a second third of the spit zone.

FIG. 3c schematically illustrates the segmented spit zone of FIG. 3a, with a black color ejection device performing a maintenance spit at a random position in a second third of the spit zone.

FIG. 4a schematically illustrates a spit zone in segmented in two spitting segments and a black color ejection device performing a maintenance spit at a random position in a first half of the spit zone.

FIG. 4b schematically a black color ejection device performing a maintenance spit at a random position in a second half of the spit zone.

FIG. 5 schematically illustrates subroutines of a printer controller performed at ejection device maintenance.

FIG. 6 schematically illustrates a flowchart of an ejection device maintenance method involving spitting maintenance ink at random positions into a spittoon.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Examples provided herein include an inkjet printer comprising an ejection device, movably provided along a print zone and a spit zone and, for example, a capping zone the inkjet printer may be a multiple-color printer or a black ink printer. Correspondingly the ejection device may be any color cartridge, a combination cartridge (CYMK cartridge) or a black-ink cartridge. In such cases, for example, there are two cartridges in an inkjet printer, one is black (K) while the other is color (cyan, magenta, yellow—CMY). The ejection device in general may be a non-integrated printhead with an ink reservoir outside the printhead or an integrated printhead, such as an ink cartridge, with an ink reservoir included in the printhead or any other ejection mechanism used for printing. The print zone may be any area within the printer that serves the purpose of ejecting ink onto a printable medium when carrying out a print-job. A spit zone may be any area in which maintenance spits are performed by the ejection device.

The inkjet printer comprises a printer controller to control ejection device maintenance. The printer controller may be any control circuit to control printing functionalities of the printer and also maintenance functionalities for an ejection device. Ejection device maintenance comprises the ejection of maintenance ink into a spittoon (also referred to herein as “spitting”) and may further comprise one of (i) wiping nozzles of the ejection device and (ii) capping nozzles of the ejection device, or a combination thereof.

For the purpose of spitting, a spittoon, located in the spit zone, is provided to receive maintenance ink ejected by the ejection device in the spit zone when the ejection device maintenance is performed. The spittoon is a receptacle to receive the maintenance ink. The maintenance ink may be the same ink as used for printing or a flushing fluid different to this printing ink. A particular maintenance ink can be provided for particular ejection devices, such as a different maintenance ink suitable for flushing color ejection devices than for flushing black ink ejection devices. The spitting, for example, removes plugs from the ejection device's nozzles (especially such formed from dried ink) and cleans debris located around the nozzles.

The printer controller to set a random spit position within the spit zone at which the ejection device is to eject the maintenance ink into the spittoon. If maintenance ink is ejected into a spittoon repeatedly at the same position, stalagmites of dried maintenance ink might form, which might interfere with the printhead/nozzle orifice plate of the ejection device and lead to malfunctions.

When moving repeatedly to random positions and ejecting maintenance ink there, what matters most may be not to hit an exact position at which ink is spit, but that each maintenance spit position is different to the foregoing ones in order to avoid stalagmite formation.

The printer controller is to cause to move to the set random spit position and to eject the maintenance ink into the spittoon at the random spit position.

In some examples, as mentioned above, the maintenance ink is a maintenance ink for black color ejection devices and the ejection device maintenance is performed on a black color ejection device. The randomized ink spitting method described herein is, for example, applied to black (K)—color ejection devices as these cartridges contain pigment ink which could build stalagmites of dried ink over time, but is not applied to color (CMY) cartridges which contain dye-based ink which does not have dry ink built up over time.

In some examples, the spittoon is designed to provide as much space for maintenance ink such that the spittoon is not full with dried maintenance ink before the end of the printer's expected lifetime.

After several cleaning cycles (e.g. 10 000 maintenance cycles or more), an expected lifetime of the printer may be reached. The expected lifetime is, for example, a statistically estimated timespan during which the printer does brake down due to wear. By designing the spittoon as such that it is not full before the end of this timespan, it is ensured that a filled-up spittoon is not the cause of a printer malfunction experienced of the printer. Also, there is no need for a mechanism to empty the spittoon on a regular basis during the printer's lifetime. The spittoon receptacle can, for example, absorb up to an amount of maintenance ink equal to what was ejected during 10 000 maintenance cycles.

A further consideration that may play a role in determining the capacity of a spittoon to be provided is, for example, the spitting distance provided (which may correspond to the length of the spittoon). The spitting distance is, for example, determined by the printer target produced width minus a length of a capping zone. Furthermore, if a separate spittoon is provided for black ink cartridge and color cartridges, for example, the spitting distance for a black ink cartridge spittoon may be determined by the printer target product width minus the length of the capping zone and minus the length of a color spitting zone including the separate spittoon for color ejection devices. Further considerations that may also apply to the width of the spittoon, are further discussed below.

In some examples, the printer controller to cause the ejection device maintenance to be performed before a print job or during the print job or in-between a print job or after a print job. When the ejection device maintenance is performed before a print job, this is, for example, the case right after the ejection device leaves a capping station within a maintenance station. A capping station is a location where the ejection device is provided with a compliance seal by an elastomer cap when it is not printing. In this case, the nozzles are spit a few times into the spittoon to ensure that the ejection device's nozzles work properly before printing on a medium.

Likewise, maintenance spits could be performed after printing on the media to clean out remaining ink in the nozzles that, if not flushed away, could dry and form plugs clogging the nozzles. The ejection device maintenance could be also performed during a print job, hence, for example, during printing a page. The ejection device could move quickly to the spit zone, perform the maintenance spit(s), and return again to the printing task performed.

In some examples, the printer controller to cause the ejection device maintenance to be performed after printing a page has been finished and before printing of a page starts. In these examples, the ejection device maintenance is, for example, performed in-between a print job. After having finished printing a page, the ejection device may move to the spit zone and eject maintenance ink there at a random position within the spit zone. As ejection device maintenance is performed in these examples for practically each page printed, less maintenance spits are needed for each maintenance cycle, which reduces the total amount of maintenance ink consumed while still preventing nozzles from clogging and clearing an ink ejection zone from debris.

In some examples, the printer controller to cause all nozzles of the ejection device to fire at the same time when ejecting the maintenance ink into the spittoon. As such, all nozzles of the ejection device are fired every time when ejection device maintenance is performed. This allows for finishing the ejection device maintenance in a minimum amount of time.

In some examples, the printer controller to divide the spit zone into segments when setting the random spit position within the spit zone and to set a random spit position in one of these segments of the spit zone.

The segments into which the spit zone is divided by the printer controller are no physical segments in the sense of a physical separation of different segments of the spit zone. Those segments correspond, for example, to a certain partial areas (volumes) within the spit zone in which a maintenance spit is performed.

In these examples, the printer controller to set a first random spit position in a first segment of the spit zone and to cause the ejection device to move to the first random spit position in the first segment of the spit zone and to eject fluid at first the random spit position in the first segment of the spit zone. The first segment of the spit zone is, for example, a first half, a first third or a first quarter of the spit zone.

The controller is in these examples to set a second random spit position in a second segment of the spit zone, wherein the second segment is a segment of the spit zone that is different to the first segment. The controller to cause the ejection device to move to the second random spit position in the second segment of the spit zone and to eject fluid at the second random spit position in the second segment of the spit zone, after the ejection device has ejected fluid into the spittoon at the first random spit position in the first segment of the spit zone.

In these examples, the surface area of the different segments is equal (and the corresponding volume of the spittoon). In this way, the first segment, for example, covers a first third, a second segment a second third and a third segment a third of the spit zone. By choosing different segments with equal surface area, the likelihood of a certain random spit position to be set is approximately equal for each possible spit position within the spit zone when, for a plurality of spits, for each maintenance spit a different segment is selected.

In some examples, the printer controller to divide the spit zone into two halves, when setting the random spit position within the spit zone, and to set a first random spit position in a left half of the spit zone and to set a second random spit position to be located in the right half of the spit zone. The printer controller further to cause the ejection device to move to the first random spit position in the left half of the spit zone and to eject fluid at the first random spit position in the left half of the spit zone. It is noted that the terms “left half” and “right half” are merely used to simplify explanation and it is to be understood that the terms “left” and “right” are therefore not intended to be understood in a restrictive sense. The same applies to terms like “left-hand side” and right-hand side”.

After the ejection device has ejected fluid into the spittoon at the random spit position in the left half of the spit zone, for example, the print controller to set a second random spit position in the right half of the spit zone and to cause the ejection device to move to the second random spit position in the right half of the spit zone and to eject fluid at the second random spit position in the right half of the spit zone.

Setting a random spit position and spitting in the left half and then setting a spit position in the right half and spitting in the right half and so on may be repeated for a predetermined number of times until a maintenance cycle is completed. As such, for example, ten spits at random spit positions in the right half of the spit zone may be performed as well as ten spit at random spit positions in the left half of the spit zone.

In some examples, the spittoon is designed such that the width of the spittoon is slightly larger than a length of an ejection zone of the ejection device and a length of the spittoon exceeds the width of an ejection zone of the ejection device.

By this design, the spit zone (which may practically correspond to the area covered by the spittoon), may be a prolongation of the print zone. The ejection device can be carried over the spit zone by the same guide rail mechanism as over the print zone. For setting the random spit position, in this way, for example, one coordinate along the guide rail is needed to specify a random spit position.

In some examples, the printer controller to cause the ejection device to move towards the random spit position with substantially the same speed as a ejection device speed applied for printing in the print zone and causes the ejection device to stop at the random spit position when the random spit position is reached.

As mentioned above, when maintenance ink is repeatedly ejected at the same spot into the spittoon, stalagmites of dried ink might form in the spittoon. In one implementation of maintenance spitting, ejection devices are moved at a slow speed over the spittoon to avoid uneven buildup of maintenance ink. However, there may be a desire to perform maintenance spitting at a higher speed, such as to reduce printing delays. Thus, in another implementation, it may be possible to reduce an amount of time speni performing maintenance spitting though the use of random spitting locations. For example, when maintenance spits are performed at random spit positions, it may be possible to avoid carriage speed reductions to arrive at predetermined spitting locations. As mentioned above, what matters is that successive spit positions are different to each other. Hence, ejection device speed does not have to be reduced when moving the ejection device towards the set random spit position. The same ejection device speed may be applied as during printing.

In some examples, setting the random spit position of the ejection device comprises an association of random numbers produced by standard random number generator with different positions of the ejection device in the spit zone. In these examples, for example, any standard random number generating function (such as the rand( ) or stand( ) function) is used as a standard random number generator. The random number generator, for example, outputs random numbers between certain limits. e.g. “0” and “1” or between “1” and “100”. Each random number output may be associated with a certain spit position in the spit zone. To provide an example, when random numbers between “1” and “100” are used, the random number “l” could stand for an outmost left position in the spit zone, whereas the random number “100” could stand for an outmost right position in the spit zone. As the ejection device is, for example, moved over the spit zone over a fixed guiderail, a single number is, for example, sufficient to specify a distinct position in the spit zone.

In some examples, the spit zone is part of a maintenance station which further comprises a capping station. As mentioned above, the capping station serves to cap nozzles when they are not in operation in order to prevent ink remaining in the nozzles of drying and forming plugs.

In some examples, the spit zone is arranged at one side of a print zone. Thereby, when ejection device maintenance is performed, the ejection device can be moved simply into the spit zone located, for example, adjacent to the print zone. This makes the distance for the ejection device to be moved short and enables a printer design with a minimum of space occupied. For example, a capping station is located on the left-hand side of the print zone while the spit zone is located (adjacent to) the print zone on the right-hand side of the print zone.

The examples described herein also relate to a method of maintaining an ejection device comprised by an inkjet printer. The method comprises setting a random spit position within a spit zone of an inkjet printer at which the ejection device is to eject maintenance ink into a spittoon and moving the ejection device to the set random spit position and eject, by the ejection device, the maintenance ink into the spittoon at the random spit position.

The method of maintaining a ejection device comprised by an inkjet printer comprises any of the functions described in conjunction with examples pertaining to the inkjet printer disclosed herein.

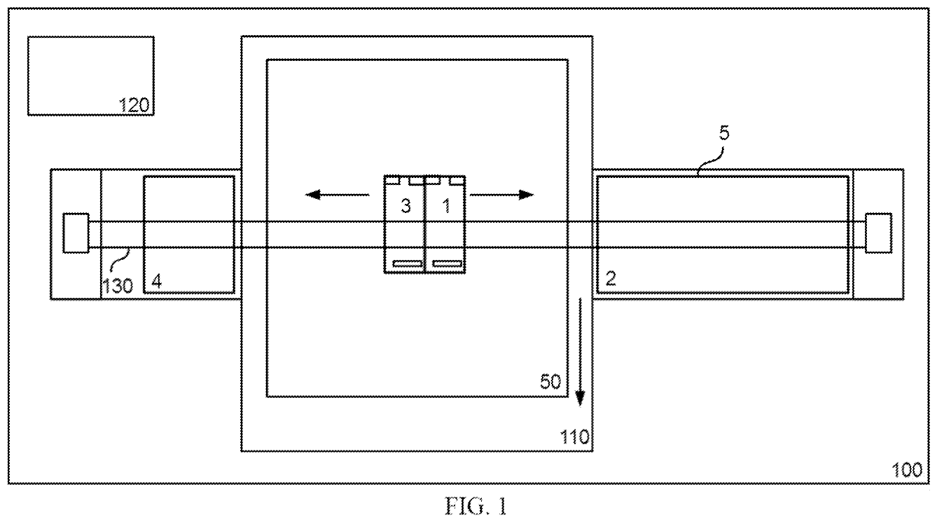

Referring to FIG. 1, an example of a printer assembly 100 is illustrated. The printer assembly 100 comprises a printer controller 120. The printer controller is, for example, to control print operations performed by the printer 100. For printing e.g. on a sheet of paper arranged in the print zone 50, e.g. ejection devices 1, 3 move from one side of the printer to the other (indicated by horizontal arrows in both directions in FIG. 1) on a guide rail 130, while the paper advances in a direction perpendicular to the direction of movement of ejection devices 1, 3 (indicated by the vertical arrow in FIG. 1). Printing is performed, e.g. by the ejection devices 1, 3 ejecting ink on the paper. There are two cartridges 1, 3 in the printer assembly 100, cartridge 1 is black (K) while the other cartridge 3 is color (cyan, magenta, yellow—CMY).

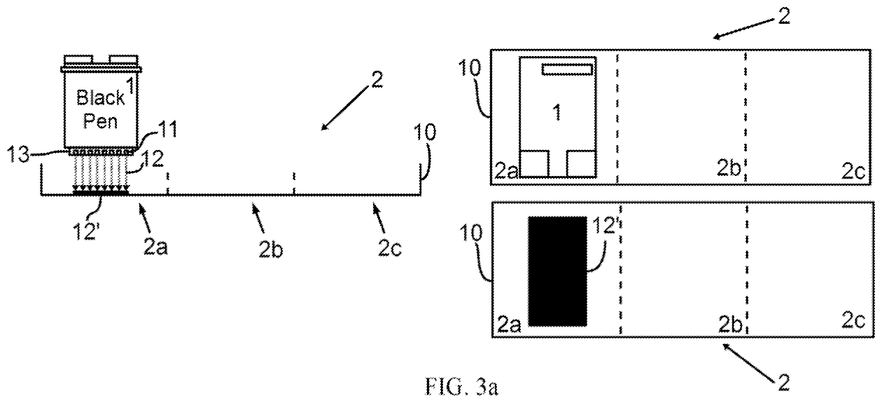

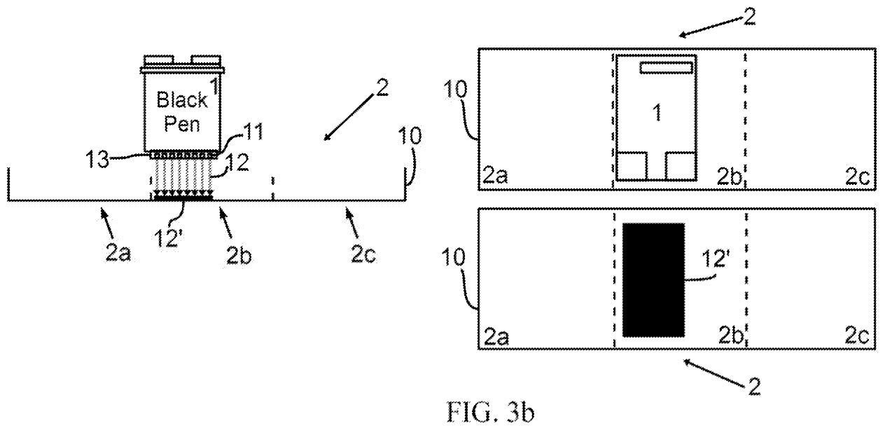

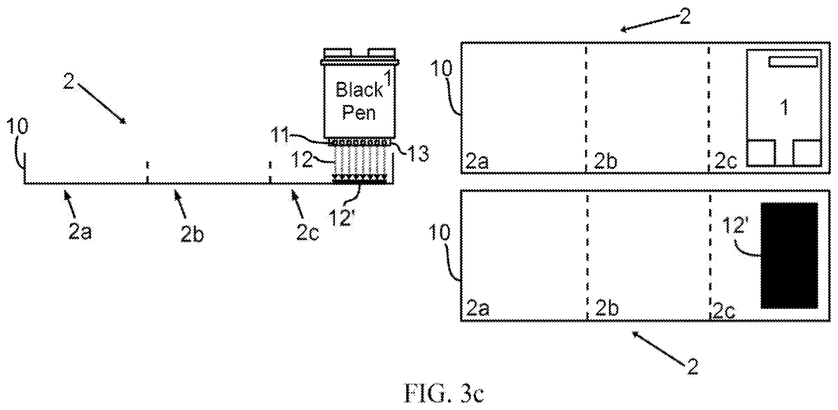

The printer controller 120 is, however, also to control ejection device maintenance operations. When ejection device maintenance is performed, the black ejection device 1 is moved along the guide rail 130 to a maintenance station 5. The black ink cartridge 1 is mover there, for example, together with the color cartridge 3. The maintenance station 5 comprises a spit zone 2. The spit zone 2 comprises a spittoon 10 (see FIGS. 3 to 5) into which maintenance ink 12 (see FIGS. 3 to 5) is to be ejected. The ejection of maintenance ink into the spittoon 10 (spitting), for example, removes plugs from nozzles of the black ink ejection device 1 and also clears debris from around the nozzles 11 (see FIGS. 3 to 5). The maintenance ink 12 is either, the same ink as the ink used for printing on the paper, e.g. black ink or a flushing fluid suiting the type of ejection device used.

Spitting is performed, e.g. before starting a print job after the ejection device 1 leaves the capping station 4 or in-between a print job, such as after printing the first page of the print job is finished. The capping station 4, located on the left-hand side of the print zone 50, caps the ink cartridge 1 to prevent ink from drying on the ink ejection zone (see FIGS. 3 to 5). In a wiping station (not shown in FIG. 1), which may be located within the print zone 50, the nozzles 11 of the ink cartridge are wiped to further remove debris and obstacles, such as dried ink.

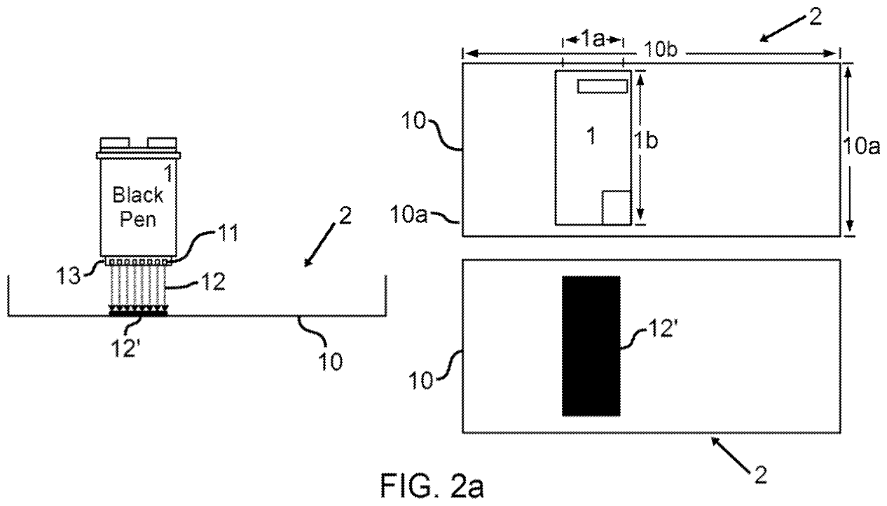

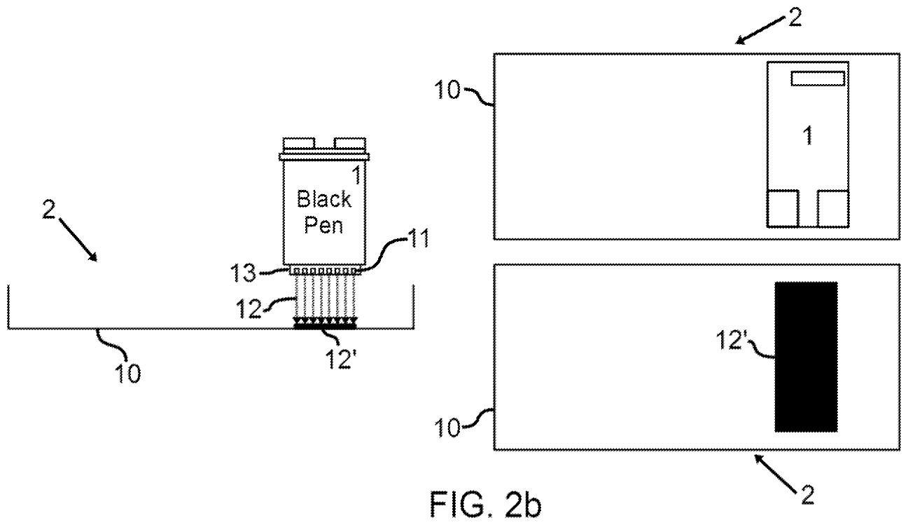

In the two subsequent ejection device maintenance cycles schematically illustrated by FIGS. 2a and 2b, the ejection device 1 ejects maintenance ink 12, for example, at two random spit positions in the spit zone 2. The spit zone 2, in this example, corresponds to the length and width of the spittoon 10.

The ink cartridge 1 is a black color cartridge, which moves to its first spit position, for example, with the same speed as applied for printing a page, namely 40 ips (inch per second). A speed of 40 ips is possible in one case, but also other scan speeds are contemplated by the claims. This high speed of moving towards the spit position is possible as the spit position is chosen randomly and small positioning errors relative to the randomly set spit position can thus be tolerated.

On the left-hand side of FIG. 2a, the ejection device 1 is illustrated as it ejects ink into the spittoon 10 located in the spit zone 2 in a side perspective view. All nozzles 11 of the cartridge, located in an ink ejection zone 13 fire at once to eject streams of maintenance ink 12, in order to finish the maintenance cycle for all nozzles 11 as soon as possible.

On the right-hand side, the cartridge 1 spitting into the spittoon 10 is shown in a top perspective view, as well as the ejected maintenance ink 12′ in the spittoon 10. The spittoon 10 is designed as such that the width of the spittoon (see reference sign 10a) is slightly larger than the length of the ejection device (see reference sign 1b) and the length of the spittoon (see reference sign 10b) is larger than the width of the ink cartridge's ejection zone 13 (see reference sign 1a).

After the ink ejection schematically shown in FIG. 2a the printer might continue printing a page and might perform the ink ejection schematically shown in FIG. 2b when the printing of the page has finished.

FIG. 2b illustrates one example of how the ejection device 1 ejects maintenance ink 12 at a second random spit position in the spit zone 2 into the spittoon. This is the second spit of the maintenance cycle illustrated by FIGS. 3a and 3b. It is noted here that an arbitrary number of spits at an arbitrary number of random spit positions in the spit zone can be performed in a maintenance cycle and that FIGS. 3a and 3b illustrate an example of ejection device maintenance.

FIGS. 3a to 3c schematically illustrate example maintenance ink ejections at positions that are randomly chosen within different segments 2a, 2b, 2c of the spit zone 2.

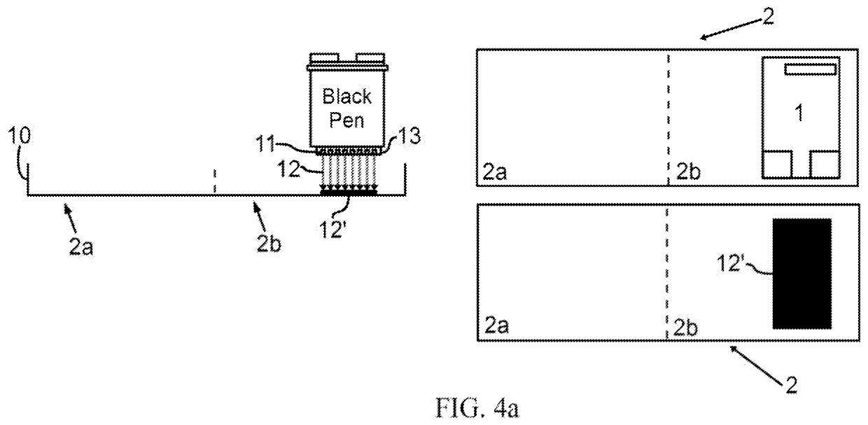

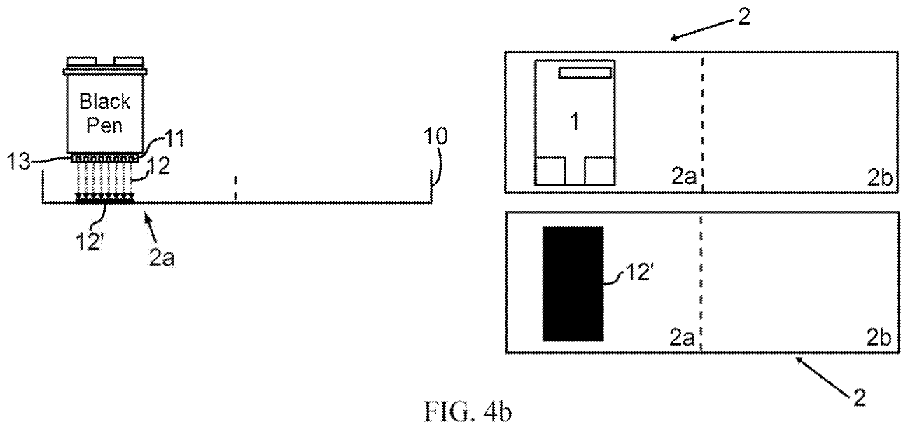

The spit zone 2 schematically illustrated in FIGS. 3a to 3c, is segmented in three spit segments 2a, 2b, and 2c. The segments are illustrated in FIGS. 4a to 4c by dashed lines that separate the spit zone 2 into three parts of equal surface area. The spit zone 2, in this example, corresponds to the length and width of the spittoon 10.

The spit position as shown in FIG. 3a is, for example, randomly set in the first segment 2a of the spit zone. After ejection of maintenance ink in this first segment 2a of the spit zone, the printer might continue printing and for the next maintenance cycle a random spit position in a second segment 2b of the spit zone is set and the ejection device ejects maintenance ink there, as illustrated in FIG. 4b, by way of example. Correspondingly, after ink has been ejected at the second random spit position, a third random spit position is set in a third segment 2c in the upcoming maintenance cycle and maintenance ink is ejected there as schematically illustrated in FIG. 3c.

It is noted that in FIGS. 3a to 3b, the total surface area covered by the spit zone 2 is subdivided into three equal segments 2a, 2b, 2c, by way of example but not limitation. The surface area covered of the three segments 2a, 2b, 2c is equal. Therefore, when setting random positions in each segment and performing spitting there sequentially, the likelihood of setting a certain position and spitting on that position in the entire spit zone 2 is approximately the same for each spit position within the spit zone for an ejection device maintenance cycles comprising a plurality of subsequent ink ejections at different positions in the spit zone 2.

FIGS. 4a and 4a schematically illustrate the same principle as FIGS. 3a to 3c. However, in the example of FIGS. 3a to 3b the spit zone 2 was segmented in three equal segments 2a, 2b and 2c, whereas in the example of FIGS. 4a and 4b the spit zone is segmented in two segments of equal surface area, i.e. it is split in half.

As schematically illustrated by FIG. 4a, a first random spit position is set in the left half 2a of the spit zone. Maintenance ink 12 is at this position there by the ejection device 1 which is a black pen cartridge. Thereafter, as schematically illustrated by FIG. 4b, the printer continues printing until a page has finished and a second random spit position is set in the right half 2b of the spit zone 2 and maintenance ink 12 is also ejected there accordingly. The activities illustrated by FIGS. 4a and 4b are example activities of ejection device maintenance. Different random spit positions may be set in the right and the left segment 2a, 2b of the spit zone alternately for an arbitrary number of times when a print job is performed and a maintenance spit either in the right half or the left half of the spit zone is performed, e.g. after printing of a page of the print job has been finished. It is to be understood that while examples of a spittoon subdivided into two and three segments are provided, there may be a number of other implementations in which other numbers of segments may be used, without limitation. Furthermore, while the present description suggests that maintenance spit occurs in some examples in a discrete spit zone, in one implementation in which spitting is randomized, maintenance spit may occur between zones, for example, at the boundary between two zones. It is noted that unless explicitly recited otherwise, the claims contemplate such maintenance spitting.

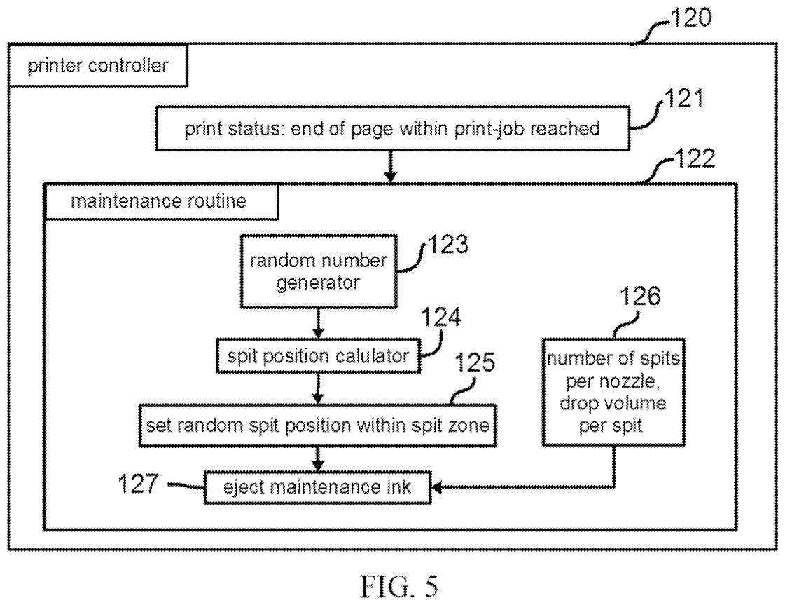

FIG. 5 shows a block diagram of a printer controller 120 with example subroutines. In the example illustrated by FIG. 5, the printer controller is to cause ejection device maintenance to be performed after printing a page of a print job has been finished and before printing of the next page of the print job starts.

At reference numeral 121 the printer controller receives a print status indicating that the end of the print job's page has been reached. After receiving this status, the printer controller is to start a maintenance routine 122. Part of this maintenance routine is, for example, a standard random number generator 123, such as the rand( ) function. This random number generator 123 provides a spit position calculator 124 with random numbers, for example, between 1 and 100. Within the spit position calculator 124, there may be stored an association table between each number between 1 and 100 and a certain coordinates of spit positions within the spit zone for the ejection device 1. Any other possible method of providing an association between a random number generated by random number generator 123 and positions within a spit zone of a spittoon may be used.

As such, based on the association between the random numbers generated by the random number generator 123 and an ejection device position within the spit zone is calculated in spit position calculator 124. This position is set as random spit position within the spit zone at reference numeral 125.

Based, for example, on information stored e.g. on an ejection device memory or on a printer memory, as the number of spits per nozzle and the drop volume per spit for the maintenance routine 126, maintenance ink is ejected at reference numeral 127.

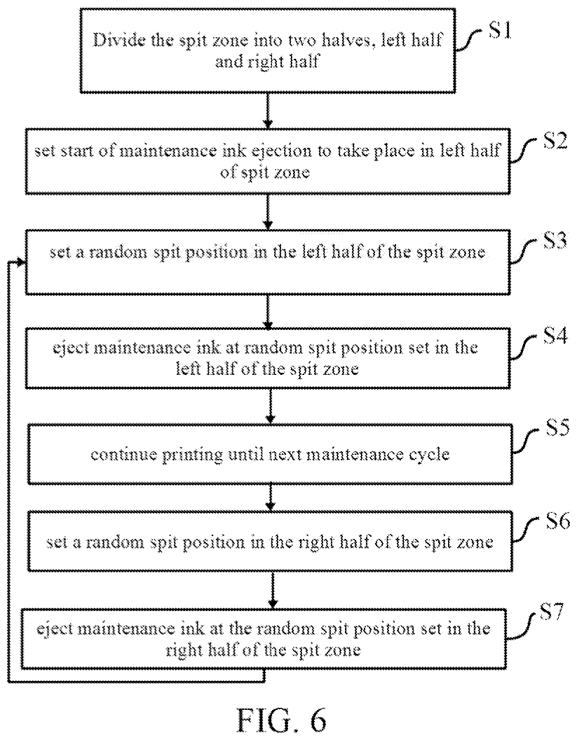

FIG. 6 schematically illustrates an example flowchart of an ejection device maintenance method involving spitting maintenance ink at random positions into a spittoon.

In activity S1, the spit zone is divided into two halves, a left half and a right half. This subdivision corresponds, for example, to the one shown and described in conjunction with FIGS. 4a and 4b.

In activity S2, it is set that the start of maintenance ink ejection is to take place in the left half of the spit zone.

In activity S3, a random spit position in the left half of the spit zone is set.

In activity S4 maintenance ink is ejected at the random spit position set in the left half of the spit zone.

In activity S5, after ink has been ejected into the spit zone, printing continues until the next maintenance cycle is to be performed.

In activity S6, which marks the start of a new maintenance cycle, a random spit position is set in the right half of the spit zone.

In activity S7, maintenance ink is ejected at the random spit position set in the right half of the spit zone. The activities S1 to S4 and S6 to S7 correspond, for example, to what is schematically illustrated in FIGS. 4a and 4b.

After activity S7, the ejection device maintenance method continues with activity S3.

It is to be understood that the examples disclosed herein are provided for illustrative purposes and are not to be construed as limiting the scope of the present disclosure.

1. An inkjet printer comprising:
an ejection device movably provided along a print zone and a spit zone,
a printer controller to control ejection device maintenance, and
a spittoon located in the spit zone to receive maintenance ink ejected by the ejection device in the spit zone when ejection device maintenance is performed,
wherein the printer controller to
set a random spit position within the spit zone at which the ejection device is to eject the maintenance ink into the spittoon, and
cause the ejection device to move to the set random spit position and to eject the maintenance ink into the spittoon at the random spit position.

2. The inkjet printer of claim 1, wherein the maintenance ink is a maintenance ink for black color ejection devices and the ejection device maintenance is performed on a black color ink cartridge.

3. The inkjet printer of claim 1, wherein the spittoon is designed to provide as much space for maintenance ink such that the spittoon is not full with dried maintenance ink before an end of an expected lifetime of the printer.

4. The inkjet printer of claim 1, wherein the printer controller to cause the ejection device maintenance to be performed in-between a print job.

5. The inkjet printer of claim 1, wherein the printer controller to cause the ejection device maintenance to be performed after printing a first page has been finished and before printing of a second page starts.

6. The inkjet printer of claim 1, wherein the printer controller to cause all nozzles of the ejection device to fire concurrently to eject the maintenance ink into the spittoon.

7. The inkjet printer of claim 1, wherein to set the random spit position, the printer controller to divide the spit zone into segments and to set a random spit position in one of the segments of the spit zone.

8. The inkjet printer of claim 1, wherein to set the random spit position, the printer controller to divide the spit zone into segments and to set a first random spit position in a first segment of the spit zone and to cause the printhead to move to the first random spit position in the first segment of the spit zone and to eject fluid at the first random spit position in the first segment of the spit zone and to set a second random spit position in a second segment of the spit zone, the second segment different from the first segment, and to cause the printhead to move to the second random spit position in the second segment of the spit zone and to eject fluid at the second random spit position in the second segment of the spit zone, after the printhead has ejected fluid into the spittoon at the first random spit position in the first segment of the spit zone.

9. The inkjet printer of claim 1, wherein to set the random spit position, the printer controller to divide the spit zone into two halves and to set a first random spit position in a left half of the spit zone and to set a second random spit position to be located in a right half of the spit zone and to cause the ejection device to move to the first random spit position in the left half of the spit zone and to eject fluid at the first random spit position in the left half of the spit zone, wherein after the ejection device has ejected fluid into the spittoon at the random spit position in the left half of the spit zone, the print controller is to set a second random spit position in the right half of the spit zone and to cause the ejection device to move to the second random spit position in the right half of the spit zone and to eject fluid at the second random spit position in the right half of the spit zone.

10. The inkjet printer of claim 1, wherein the spittoon is designed such that a width of the spittoon is slightly larger than a length of an ejection zone of the ejection device and a length of the spittoon exceeds the width of an ejection zone of the ejection device.

11. The inkjet printer of claim 1, wherein the printer controller to cause the ejection device to move towards the random spit position with substantially an equal speed as a cartridge speed applied for printing in the print zone and to cause the ejection device to stop at the random spit position when the random spit position is reached.

12. The inkjet printer of claim 1, wherein the spit zone is arranged at one side of a print zone.

13. The inkjet printer of claim 1, wherein the spit zone is arranged at a right-hand side of the print zone and a capping station is arranged at a left-hand side of the print zone.

14. The inkjet printer of claim 1, wherein setting the random spit position of the ejection device comprises an association of random numbers produced by standard random number generator with different positions of the ejection device in the spit zone.

15. A method of maintaining an ejection device comprised by an inkjet printer, the method comprising:
setting a random spit position within a spit zone of an inkjet printer at which ejection device is to eject maintenance ink into a spittoon
moving the ejection device to the set random spit position and eject, by the ejection device, the maintenance ink into the spittoon at the random spit position.
